(19) United States
(12) Patent Application Publication
(10) Pub. No.: US 2020/0264873 A1
(43) Pub. Date: Aug. 20, 2020

(54) SCALAR UNIT WITH HIGH PERFORMANCE IN CRYPTO OPERATION

(71) Applicant: Nanjing Iluvaar CoreX Technology Co., Ltd. (DBA "Iluvatar CoreX Inc. Nanjing"), Nanjing (CN)

(72) Inventors: Pei Luo, San Jose, CA (US); Pingping Shao, San Jose, CA (US); Cheng Li, San Jose, CA (US)

(73) Assignee: Nanjing Iluvatar CoreX Technology Co., Ltd. (DBA ? Iluvatar CoreX Inc. Nanjing?), Nanjing (CN)

(21) Appl. No.: 16/281,086

(22) Filed: Feb. 20, 2019

(51) Int. Cl. G06F 9/30; G06F 21/60

(52) U.S. Cl. CPC G06F 9/3001; G06T 1/20; G06F 21/602

(57) ABSTRACT

Embodiments of the invention provide a technical solution by making changes of scalar units to enable it for cryptography applications with high performance. Aspects of the invention provide a scalar unit having four 32-bit arithmetic logic units (ALUs). These four ALUs may be used as independently as four individual lanes, each generates 32-bit results. As such, the Instruction per Cycle (IPC) may be 4. In addition, these four sets of 32-bit ALUs may be configured as two 64-bit ALUs with each two of the 32-bit ALUs in one group. This configuration may, in one embodiment, generate two 64-bit results each cycle. Moreover, these four sets of 32-bit ALUs may be configured as one 128-bit ALU when the ALUs are combined as one single unit. Aspects of the invention create an output from the set of four 32-bit scalar ALUs with data width or format that is other than 32-bit.

### TECHNICAL FIELD

Embodiments of the invention generally relate to providing an enhanced scalar operations.

### BACKGROUND

Vector processing in processors, such as central processing unit (CPU) or graphics processing unit (GPU), implements an instruction set containing instructions that operate on one-dimensional arrays of data called vectors. This is in contrast to scalar processors, whose instructions operate on single data items.

A vector instruction typically performs an operation on each data element in consecutive cycles. The vector functional units in the instruction are pipelined. In addition, each pipeline stage operates on a piece of data, and there are no vector dependencies (internally and between vectors).

However, there are disadvantages, notably if vector operations are irregular. At the same time, memory access may be bottlenecked if memory operation balance is not monitored and maintained and that data is not mapped correctly or appropriately to the proper memory banks.

As for a scalar processing, it typically is classified as a SISD processing (Single Instruction, Single Data). Another variation of this approach is a single instruction, multiple tread (SIMT) processing. Conventional SIMT multithreaded processors provide parallel execution of multiple threads by organizing threads into groups and executing each thread on a separate processing pipeline, scalar or vector pipeline. An instruction for execution by the threads in a group dispatches in a single cycle. The processing pipeline control signals are generated such that all threads in a group perform a similar set of operations as the threads traverse the stages of the processing pipelines. For example, all the threads in a group read source operands from a register file, perform the specified arithmetic operation in processing units, and write results back to the register file. SIMT requires additional memory for replicating the constant values used in the same kernel when multiple contexts are supported in the processor. As such, latency overhead is introduced when different constant values are loaded from main memory or cache.

Cryptography has employed vector processing's advantages in recent years due to vector processing's operational advantages in parallel processing. However, crypto operations, typically based on crypto algorithms and instructions, may be too slow for certain applications. For example, many cryptography algorithms require large memory and high computation performance. Vector units in general purpose GPUs (GPGPUs) do not have large memory per thread. On the other hand, typical scalar units in GPGPU devices have comparatively weaker performance than vector units when it comes to cryptography operations and demands.

### SUMMARY

Embodiments of the invention may provide a technical solution by making small changes of scalar units to enable it for cryptography applications with high performance. Aspects of the invention provide a scalar unit (SU) having four 32-bit arithmetic logic units (ALUs). In one embodiment, these four ALUs may be used as independently as four individual lanes, each generates 32-bit results. As such, the Instruction per Cycle (IPC) may be 4. In addition, these four sets of 32-bit ALUs may be configured as two 64-bit ALUs with each two of the 32-bit ALUs in one group. This configuration may, in one embodiment, generate two 64-bit results each cycle. Moreover, these four sets of 32-bit ALUs may be configured as one 128-bit ALU when the ALUs are combined as one single unit. Aspects of the invention create an output from the set of four 32-bit scalar ALUs with data width or format that is other than 32-bit.

Moreover, aspects of the invention create a new controller for managing and utilizing scalar units in such fashion.

### BRIEF DESCRIPTION OF THE DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating a new controller enabling a modified scalar unit organization according to one embodiment of the invention.

FIG. 2 is a diagram illustrating an ISA format to utilize the modified scalar unit organization according to one embodiment of the invention.

FIGS. 3A to 3B are schematics for a pipeline design of a modified scalar unit organization according to one embodiment of the invention.

FIG. 4 is a flow chart illustrating a method for configuring a variable data width output from a set of scalar arithmetic logic units (ALUs) according to one embodiment of the invention.

FIG. 5 is a block diagram illustrating a computer system configured to implement one or more aspects of the present invention;

FIG. 6 is a block diagram of a parallel processing subsystem for the computer system of FIG. 5, according to one embodiment of the present invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

In general, a computational core (see GPC 514 below) utilizes programmable vertex, geometry, and pixel shaders. Rather than implementing the functions of these components as separate, fixed-function shader units with different designs and instruction sets, the operations are instead executed by a pool of execution units with a unified instruction set. Each of these execution units may be identical in design and configurable for programmed operation. In one embodiment, each execution unit may be capable of multi-threaded operation simultaneously. As various shading tasks may be generated by the vertex shader, geometry shader, and pixel shader, they may be delivered to execution units to be carried out.

As individual tasks are generated, an execution control unit (may be part of the GPC 514 below) handles the assigning of those tasks to available threads within the various execution units. As tasks are completed, the execution control unit further manages the release of the relevant threads. In this regard, the Execution control unit is responsible for assigning vertex shader, geometry shader, and pixel shader tasks to threads of the various execution units, and also performs an associated “bookkeeping” of the tasks and threads. Specifically, the execution control unit maintains a resource table (not specifically illustrated) of threads and memories for all execution units. The execution control unit particularly manages which threads have been assigned tasks and are occupied, which threads have been released after thread termination, how many common register file memory registers are occupied, and how much free space is available for each execution unit.

A thread controller may also be provided inside each of the execution units, and may be responsible for scheduling, managing or marking each of the threads as active (e.g., executing) or available.

According to one embodiment, a scalar register file may be connected to the thread controller and/or with a thread task interface. The thread controller provides control functionality for the entire execution unit (e.g., GPC 514), with functionality including the management of each thread and decision-making functionality such as determining how threads are to be executed.

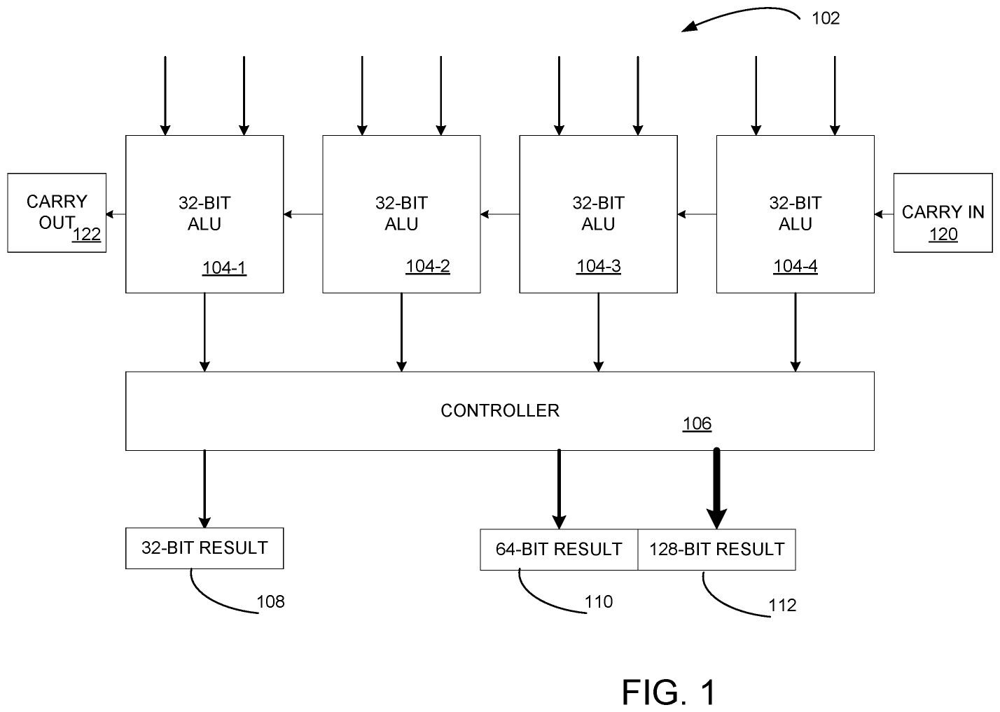

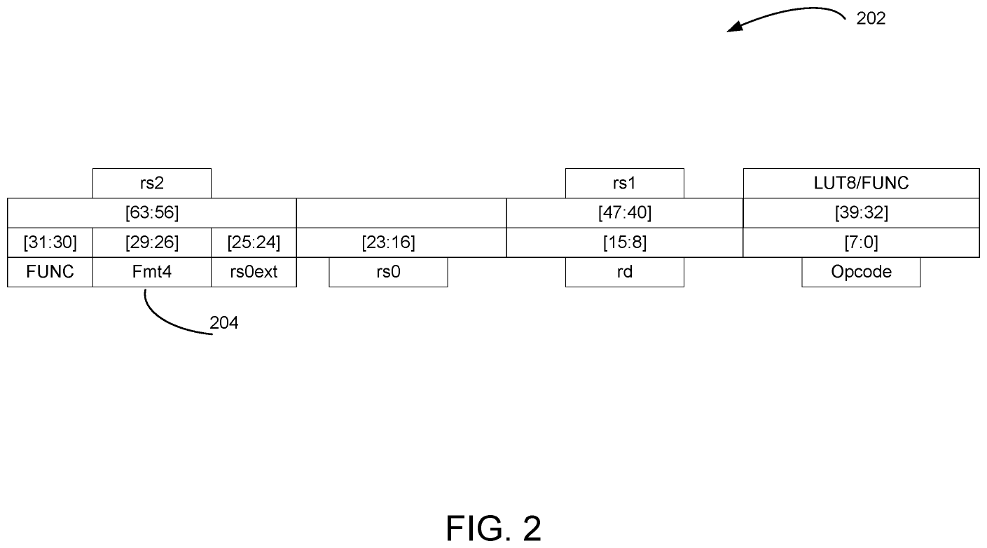

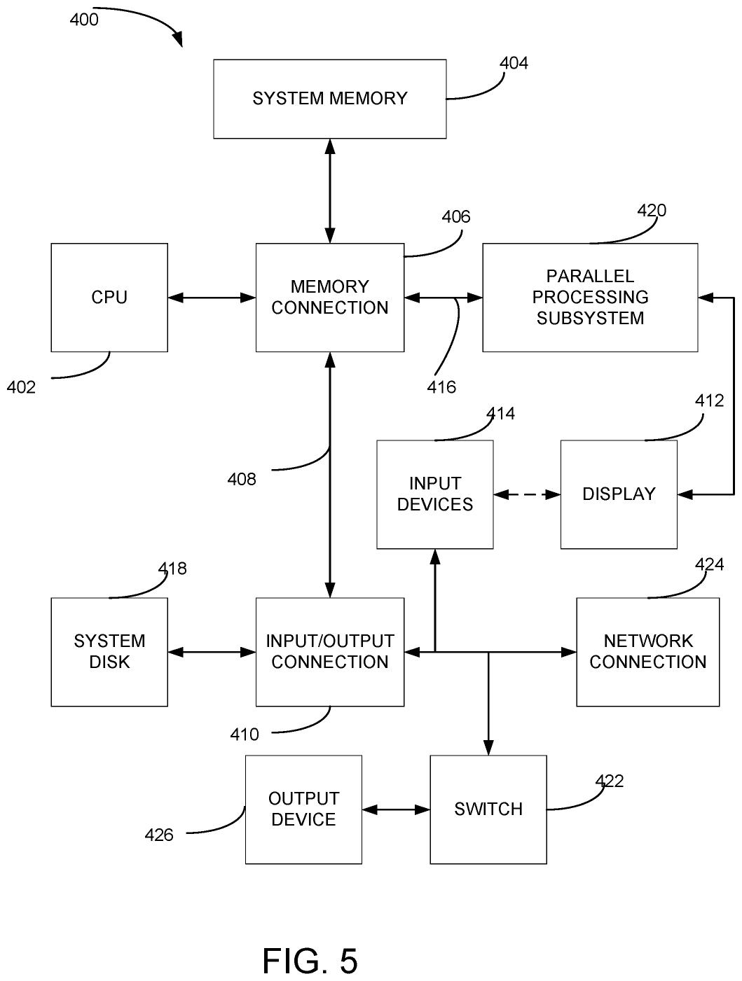

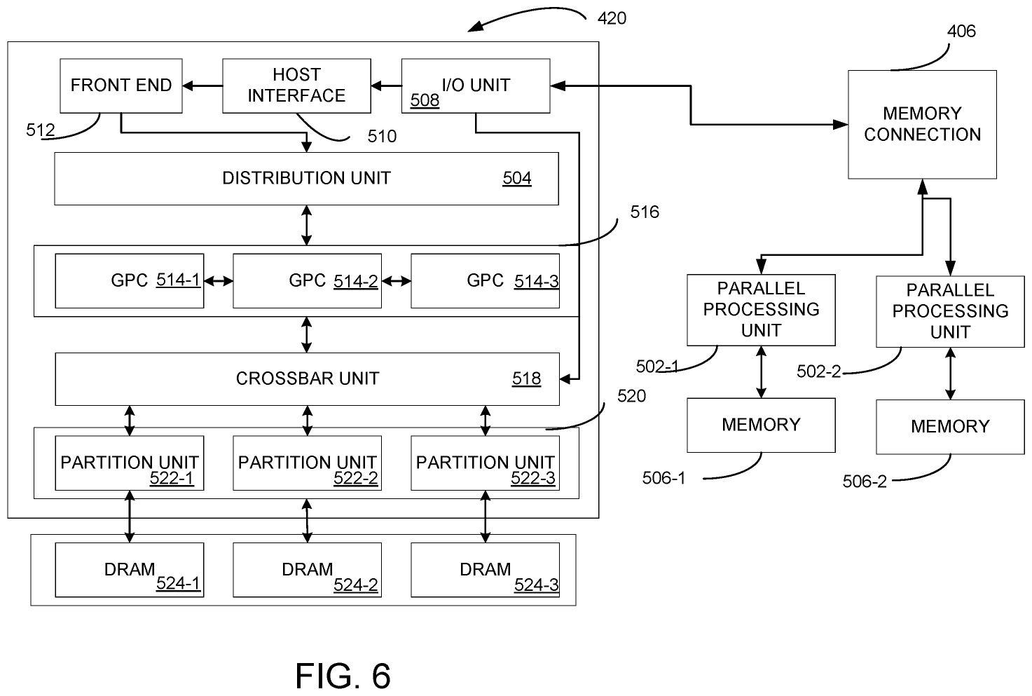

Referring now to FIG. 1, a diagram illustrates a modified scalar ALUs 102 according to one embodiment of the invention. For example, the SCALAR ALUS 102 may include four 32-bit ALUs 104-1, 104-2, 104-3, and 104-4. In one example, each of the set of 32-bit ALUs may be treated as an independent pipeline or lane for processing scalar instructions or operations. Input (carry-in 120) to the ALUs is expected to generate an output (carry-out 122). In one embodiment, a controller 106 may be added to further adding flexibility and capabilities to this modified scalar ALUs 102 arrangement or organization. For example, the controller 106 may be part of an overall execution environment, such as that of the system in FIG. 5 or 6. In another embodiment, the controller 106 may be controlled or operated in response to software or application, see also FIG. 2 below.

In one embodiment, the SCALAR ALUS 102 may be supplemented by an on-chip memory (not shown) to serve as a buffer to cache for the SCALAR ALUS 102 as the SCALAR ALUS 102 may provide the different data width results, in response to the application. For example, the size of the on-chip memory may be configured according to the applications (e.g., cryptography applications). As an example, cryptography applications may include hashing algorithms, encryption algorithms, etc. In another example, hashing or encryption algorithms include SHA-256, MD5, HMAC, Ethash, Scrypt, Equihash, Cryptonight, X11. DES/3DES or TripleDES, Blowfish, AES, Twofish, IDEA, and RSA Security.

For example, a hash is a function that converts data into a number within a certain range. The hash has the property with its output is essentially unpredictable (within the given range). In one example, a hash function used for cryptocurrency, for example, mining in cryptocurrency may require execution or application of the SHA-256 twice. As such, in any given hash algorithm, there would be input, or sometimes referred to as message, that represent the data to be hashed, and a size of bit string of a fixed size. Aspects of the invention enable the modified SCALAR ALUS 102 to provide the message and the size of bit string as configurable parameters to any given application that calls the hash algorithm and the size of the on-chip memory may be pre-determined based on the application. On the other hand, since the on-chip memory may not be changed physically on-demand, the ratio of its usage as a buffer or cache according to one embodiment of the invention. may be optimized according to the applications in question.

Referring now to FIG. 2, a diagram illustrates an instruction set architecture (ISA) format 202 to utilize the modified scalar unit organization according to one embodiment of the invention. As illustrated in FIG. 1, coupled with the controller 106, the SCALAR ALUS 102 may provide results in different data width, such as 32-bit output 108, 64-bit output, and 128-bit output. As such, in order to intelligently trigger or enable the controller to generate the desirable data width output, embodiments of the invention utilize a Fmt4 field 204 to denote the data width, whether is 32-bit, 64-bit or 128-bit. In one example, the notation in the Fmt4 field “ADD.i64” denote the addition in 64 signed integers as desirable as the output data width. In another example, “ADD.i128” may denote the addition in 128 signed integers as desirable as the output data width. Embodiments of the invention further enable to the controller to read and interpret such notation in the ISA formatted instructions. In other words, aspects of the invention enable a flexible approach to utilize 32-bit scalar ALUs to produce variable results with data width other than 32-bit.

In another example, it is to be understood that other combinations of multiples of 32-bit scalar ALUs may be used without departing from the scope or spirit of embodiments of the invention. For example, instead of a set of four 32-bit scalar ALUs, a set of four 64-bit ALUs may be configured. In another example, multiples of four in a set of 32-bit scalar ALUs may also be configured without departing from the scope or spirit of embodiments of the invention.

In other words, whenever applications wish to take advantages of the modified SCALAR ALUS 102 design to increase performance, programmers or application developers may provide notations in the ISA format field Fmt4 such that the controller 106 may interpret such notation and respond accordingly. Moreover, a portion of the on-chip memory may be allocated in response to the presence of such notation.

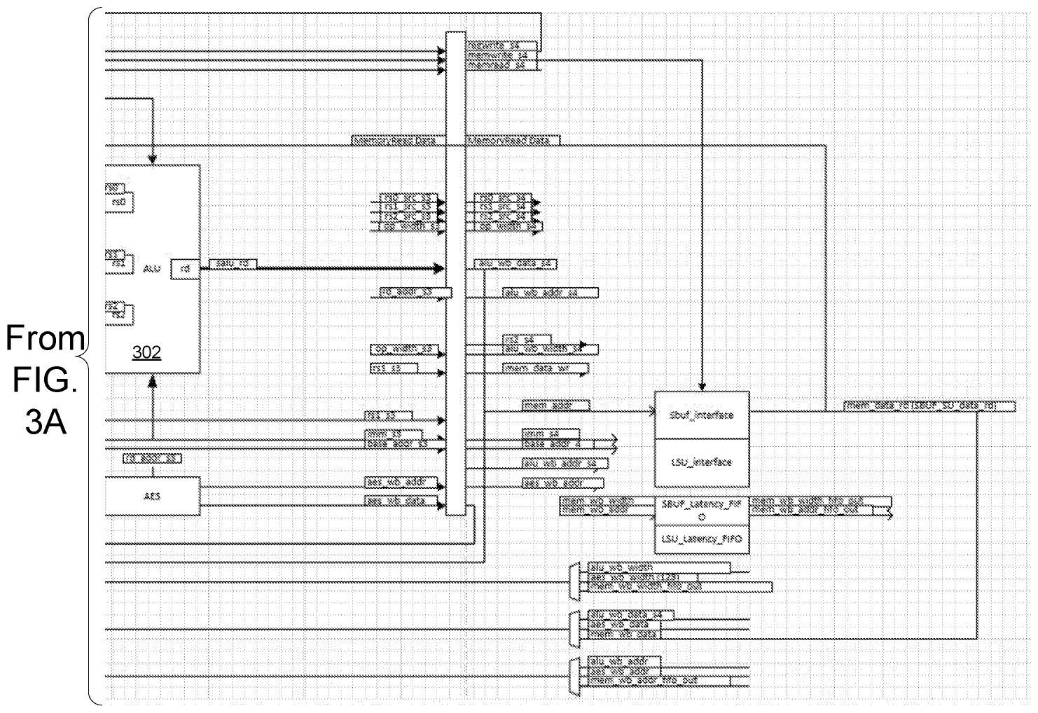

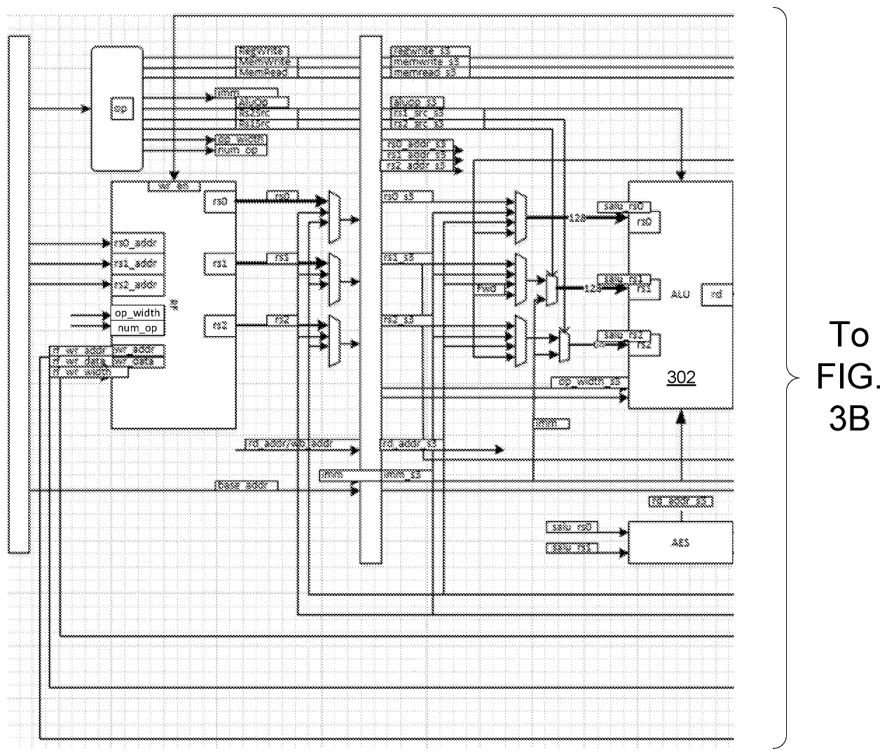

FIGS. 3A and 3B illustrate diagrams of an exemplary schematics of the modified SCALAR ALUS 102 according to one embodiment of the invention. As one would appreciate, FIG. 3A illustrates left side (e.g., inputs) of an ALU 302, while FIG. 3B illustrates the right side of the ALU 302.

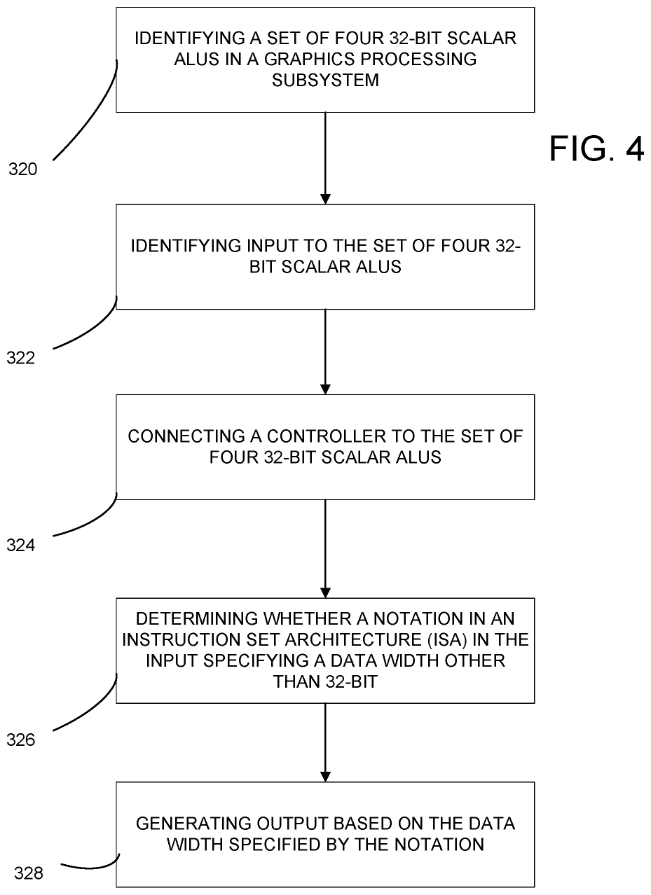

Referring now to FIG. 4, a flow chart illustrates a method for configuring a variable data format, which includes data width, output from a set of scalar units according to one embodiment of the invention. At 320, a set of four 32-bit scalar ALUs in a graphics processing subsystem may be identified. In another embodiment, the set of four 32-bit scalar ALUs may be configured or re-configured. At 322, the input to the set of four 32-bit scalar ALUs is identified. At 324, a controller to the set of four 32-bit scalar ALUs is connected. For example, the controller may be an on-chip memory serving as a cache. In another embodiment, the controller may be based on existing memory, whether it's on-chip or off-chip. It is of course desirable to deploy the controller as an on-chip memory due to the need for increasing performance. At 326, it is determined whether a notation in an instruction set architecture (ISA) in the input specifying a data width other than 32-bit. As explained above, it may be desirable to use the 32-bit scalar ALUs to provide an output whose data format or width be something other than 32-bit. In one example, the notation may be in the format of “instruction” separated by “.” and then the data format. For example, “ADD.i64” may be a syntax for such notation. It is to be understood that other notations may be used without departing from the scope or spirit of embodiments of the invention.

At 328, aspects of the invention generate ans output based on the data width specified by the notation.

FIG. 5 is a block diagram illustrating a computer system 400 configured to implement one or more aspects of the present invention. Computer system 400 includes a central processing unit (CPU) 402 and a system memory 404 communicating via an interconnection path that may include a memory connection 406. Memory connection 406, which may be, e.g., a Northbridge chip, is connected via a bus or other communication path 408 (e.g., a HyperTransport link) to an I/O (input/output) connection 410. I/O connection 410, which may be, e.g., a Southbridge chip, receives user input from one or more user input devices 414 (e.g., keyboard, mouse) and forwards the input to CPU 402 via path 408 and memory connection 406. A parallel processing subsystem 420 is coupled to memory connection 406 via a bus or other communication path 416 (e.g., a PCI Express, Accelerated Graphics Port, or HyperTransport link); in one embodiment parallel processing subsystem 420 is a graphics subsystem that delivers pixels to a display device 412 (e.g., a CRT, LCD based, LED based, or other technologies). The display device 412 may also be connected to the input devices 414 or the display device 412 may be an input device as well (e.g., touch screen). A system disk 418 is also connected to I/O connection 410. A switch 422 provides connections between I/O connection 410 and other components such as a network adapter 424 and various output devices 426. Other components (not explicitly shown), including USB or other port connections, CD drives, DVD drives, film recording devices, and the like, may also be connected to I/O connection 410. Communication paths interconnecting the various components in FIG. 5 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 420 incorporates circuitry optimized for graphics and video processing, including, for example, video output circuitry, and constitutes a graphics processing unit (GPU). In another embodiment, the parallel processing subsystem 420 incorporates circuitry optimized for general purpose processing, while preserving the underlying computational architecture, described in greater detail herein. In yet another embodiment, the parallel processing subsystem 420 may be integrated with one or more other system elements, such as the memory connection 406, CPU 402, and I/O connection 410 to form a system on chip (SoC).

It will be appreciated that the system shown herein is illustrative and that variations and modifications are possible. The connection topology, including the number and arrangement of bridges, the number of CPUs 402, and the number of parallel processing subsystems 420, may be modified as desired. For instance, in some embodiments, system memory 404 is connected to CPU 402 directly rather than through a connection, and other devices communicate with system memory 404 via memory connection 406 and CPU 402. In other alternative topologies, parallel processing subsystem 420 is connected to I/O connection 410 or directly to CPU 402, rather than to memory connection 406. In still other embodiments, I/O connection 410 and memory connection 406 might be integrated into a single chip. Large embodiments may include two or more CPUs 402 and two or more parallel processing systems 420. Some components shown herein are optional; for instance, any number of peripheral devices might be supported. In some embodiments, switch 422 may be eliminated, and network adapter 424 and other peripheral devices may connect directly to I/O connection 410.

FIG. 6 illustrates a parallel processing subsystem 420, according to one embodiment of the present invention. As shown, parallel processing subsystem 420 includes one or more parallel processing units (PPUs) 502, each of which is coupled to a local parallel processing (PP) memory 506. In general, a parallel processing subsystem includes a number U of PPUs, where LW. (Herein, multiple instances of like objects are denoted with reference numbers identifying the object and parenthetical numbers identifying the instance where needed.) PPUs 502 and parallel processing memories 506 may be implemented using one or more integrated circuit devices, such as programmable processors, application specific integrated circuits (ASICs), or memory devices, or in any other technically feasible fashion.

In some embodiments, some or all of PPUs 502 in parallel processing subsystem 420 are graphics processors with rendering pipelines that can be configured to perform various tasks related to generating pixel data from graphics data supplied by CPU 402 and/or system memory 404 via memory connection 406 and communications path 416, interacting with local parallel processing memory 506 (which can be used as graphics memory including, e.g., a conventional frame buffer) to store and update pixel data, delivering pixel data to display device 412, and the like. In some embodiments, parallel processing subsystem 420 may include one or more PPUs 502 that operate as graphics processors and one or more other PPUs 502 that are used for general-purpose computations. The PPUs may be identical or different, and each PPU may have its own dedicated parallel processing memory device(s) or no dedicated parallel processing memory device(s). One or more PPUs 502 may output data to display device 412 or each PPU 502 may output data to one or more display devices 412.

In operation, CPU 402 is the master processor of computer system 400, controlling and coordinating operations of other system components. In particular, CPU 402 issues commands that control the operation of PPUs 502. In some embodiments, CPU 402 writes a stream of commands for each PPU 502 to a pushbuffer (not explicitly shown in either FIG. 5 or FIG. 6) that may be located in system memory 404, parallel processing memory 506, or another storage location accessible to both CPU 402 and PPU 502. PPU 502 reads the command stream from the pushbuffer and then executes commands asynchronously relative to the operation of CPU 402.

Referring back now to FIG. 6, each PPU 502 includes an I/O (input/output) unit 508 that communicates with the rest of computer system 400 via communication path 416, which connects to memory connection 406 (or, in one alternative embodiment, directly to CPU 402). The connection of PPU 502 to the rest of computer system 400 may also be varied. In some embodiments, parallel processing subsystem 420 is implemented as an add-in card that can be inserted into an expansion slot of computer system 400. In other embodiments, a PPU 502 can be integrated on a single chip with a bus connection, such as memory connection 406 or I/O connection 410. In still other embodiments, some or all elements of PPU 502 may be integrated on a single chip with CPU 402.

In one embodiment, communication path 416 is a PCI-EXPRESS link, in which dedicated lanes are allocated to each PPU 502, as is known in the art. Other communication paths may also be used. An I/O unit 508 generates packets (or other signals) for transmission on communication path 416 and also receives all incoming packets (or other signals) from communication path 416, directing the incoming packets to appropriate components of PPU 502. For example, commands related to processing tasks may be directed to a host interface 510, while commands related to memory operations (e.g., reading from or writing to parallel processing memory 506) may be directed to a memory crossbar unit 518. Host interface 510 reads each pushbuffer and outputs the work specified by the pushbuffer to a front end 512.

Each PPU 502 advantageously implements a highly parallel processing architecture. As shown in detail, PPU 502(0) includes a processing cluster array 516 that includes a number C of general processing clusters (GPCs) 514, where

Each GPC 514 is capable of executing a large number (e.g., hundreds or thousands) of threads concurrently, where each thread is an instance of a program. In various applications, different GPCs 514 may be allocated for processing different types of programs or for performing different types of computations. For example, in a graphics application, a first set of GPCs 514 may be allocated to perform patch tessellation operations and to produce primitive topologies for patches, and a second set of GPCs 514 may be allocated to perform tessellation shading to evaluate patch parameters for the primitive topologies and to determine vertex positions and other per-vertex attributes. The allocation of GPCs 514 may vary dependent on the workload arising for each type of program or computation.

GPCs 514 receive processing tasks to be executed via a work distribution unit 504, which receives commands defining processing tasks from front end unit 512. Processing tasks include indices of data to be processed, e.g., surface (patch) data, primitive data, vertex data, and/or pixel data, as well as state parameters and commands defining how the data is to be processed (e.g., what program is to be executed). Work distribution unit 504 may be configured to fetch the indices corresponding to the tasks, or work distribution unit 504 may receive the indices from front end 512. Front end 512 ensures that GPCs 514 are configured to a valid state before the processing specified by the pushbuffers is initiated.

When PPU 502 is used for graphics processing, for example, the processing workload for each patch is divided into approximately equal sized tasks to enable distribution of the tessellation processing to multiple GPCs 514. A work distribution unit 504 may be configured to produce tasks at a frequency capable of providing tasks to multiple GPCs 514 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 514 are configured to perform different types of processing. For example a first portion may be configured to perform vertex shading and topology generation, a second portion may be configured to perform tessellation and geometry shading, and a third portion may be configured to perform pixel shading in pixel space to produce a rendered image. Intermediate data produced by GPCs 514 may be stored in buffers to allow the intermediate data to be transmitted between GPCs 514 for further processing.

Memory interface 520 includes a number D of partition units 522 that are each directly coupled to a portion of parallel processing memory 506, where D≥1. As shown, the number of partition units 522 generally equals the number of DRAM 524. In other embodiments, the number of partition units 522 may not equal the number of memory devices. Persons skilled in the art will appreciate that DRAM 524 may be replaced with other suitable storage devices and can be of generally conventional design. A detailed description is therefore omitted. Render targets, such as 522-1frame buffers or texture maps may be stored across DRAMs 524, allowing partition units 522 to write portions of each render target in parallel to efficiently use the available bandwidth of parallel processing memory 506.

Any one of GPCs 514 may process data to be written to any of the DRAMs 524 within parallel processing memory 506. Crossbar unit 518 is configured to route the output of each GPC 514 to the input of any partition unit 522 or to another GPC 514 for further processing. GPCs 514 communicate with memory interface 520 through crossbar unit 518 to read from or write to various external memory devices. In one embodiment, crossbar unit 518 has a connection to memory interface 520 to communicate with I/O unit 508, as well as a connection to local parallel processing memory 506, thereby enabling the processing cores within the different GPCs 514 to communicate with system memory 404 or other memory that is not local to PPU 502. In the embodiment shown in FIG. 6, crossbar unit 518 is directly connected with I/O unit 508. Crossbar unit 518 may use virtual channels to separate traffic streams between the GPCs 514 and partition units 522.

Again, GPCs 514 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 502 may transfer data from system memory 404 and/or local parallel processing memories 506 into internal (on-chip) memory, process the data, and write result data back to system memory 404 and/or local parallel processing memories 506, where such data can be accessed by other system components, including CPU 402 or another parallel processing subsystem 420.

A PPU 502 may be provided with any amount of local parallel processing memory 506, including no local memory, and may use local memory and system memory in any combination. For instance, a PPU 502 can be a graphics processor in a unified memory architecture (UMA) embodiment. In such embodiments, little or no dedicated graphics (parallel processing) memory would be provided, and PPU 502 would use system memory exclusively or almost exclusively. In UMA embodiments, a PPU 502 may be integrated into a bridge chip or processor chip or provided as a discrete chip with a high-speed link (e.g., PCI-EXPRESS) connecting the PPU 502 to system memory via a bridge chip or other communication means.

As noted above, any number of PPUs 502 can be included in a parallel processing subsystem 420. For instance, multiple PPUs 502 can be provided on a single add-in card, or multiple add-in cards can be connected to communication path 416, or one or more of PPUs 502 can be integrated into a bridge chip. PPUs 502 in a multi-PPU system may be identical to or different from one another. For instance, different PPUs 502 might have different numbers of processing cores, different amounts of local parallel processing memory, and so on. Where multiple PPUs 502 are present, those PPUs may be operated in parallel to process data at a higher throughput than is possible with a single PPU 502. Systems incorporating one or more PPUs 502 may be implemented in a variety of configurations and form factors, including desktop, laptop, or handheld personal computers, servers, workstations, game consoles, embedded systems, and the like.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A computer-implemented method for configuring a variable data width output from a set of scalar arithmetic logic units (ALUs) comprising:
identifying a set of four 32-bit scalar ALUs in a graphics processing subsystem;
identifying input to the set of four 32-bit scalar ALUs;
connecting a controller to the set of four 32-bit scalar ALUs;
determining whether a notation in an instruction set architecture (ISA) in the input specifying a data width other than 32-bit; and
generating output based on the data width specified by the notation.

2. The computer-implemented method of claim 1, wherein the input comprises cryptography algorithms.

3. The computer-implemented method of claim 1, wherein the notation comprises identification in the Fmt4 field.

4. The computer-implemented method of claim 1, wherein the notation comprises ADD.i64.

5. The computer-implemented method of claim 1, wherein the controller comprises an on-chip memory.

6. A graphics processing subsystem for configuring a variable data width output from a set of scalar arithmetic logic units (ALUs) comprising:
a graphics processing unit (GPU) operable to:
identifying a set of four 32-bit scalar ALUs;
identifying input to the set of four 32-bit scalar ALUs;
connecting a controller to the set of four 32-bit scalar ALUs;
determining whether a notation in an instruction set architecture (ISA) in the input specifying a data format other than 32-bit; and
generating output based on the data format specified by the notation.

7. The graphics processing subsystem of claim 6, wherein the input comprises cryptography algorithms.

8. The graphics processing subsystem of claim 6, wherein the notation comprises identification in the Fmt4 field.

9. The graphics processing subsystem of claim 6, wherein the notation comprises ADD.i64.

10. The graphics processing subsystem of claim 6, wherein the controller comprises an on-chip memory.

11. A system for configuring a variable data width output from a set of scalar arithmetic logic units (ALUs) comprising:
a memory configured to store instructions for execution by an input application;
a graphics processing unit (GPU) configured to execute the input application, wherein the GPU is configured to:
identifying a set of four 32-bit scalar ALUs;
identifying input to the set of four 32-bit scalar ALUs;
connecting a controller to the set of four 32-bit scalar ALUs;
determining whether a notation in an instruction set architecture (ISA) in the input specifying a data width other than 32-bit; and
generating output based on the data width specified by the notation.

12. The system of claim 11, wherein the input comprises cryptography algorithms.

13. The system of claim 11, wherein the notation comprises identification in the Fmt4 field.

14. The system of claim 11, wherein the notation comprises ADD.i64.

15. The system of claim 11, wherein the controller comprises an on-chip memory.

16. The system of claim 11, wherein the input application comprises cryptography application.
